(19) United States
(12) Patent Application Publication
(10) Pub. No.: US 2024/0314870 A1
(43) Pub. Date: Sep. 19, 2024

(54) DATA COMMUNICATIONS SYSTEMS AND METHODS

(71) Applicant: GLO-CAP LLC, Sarasota, FL (US)

(72) Inventors: Tim Meyer, Sarasota, FL (US); Brett David Gidge, Mount Airy, MD (US); Alan Pate, Milbridge, ME (US)

(21) Appl. No.: 18/605,038

(22) Filed: Mar. 14, 2024

Related U.S. Application Data
(60) Provisional application No. 63/452,023, filed on Mar. 14, 2023.

(51) Int. Cl. H04W 76/15; H04W 28/20; H04W 88/04

(52) U.S. Cl. CPC H04W 76/15; H04W 28/20; H04W 88/04

(57) ABSTRACT

The invention is a data communications system for providing two-way transmission of digital data within the 12 GHz band.

### CROSS-REFERENCE TO RELATED APPLICATIONS

This application claims priority to, and the benefit of, U.S. Provisional Application No. 63/452,023, filed Mar. 14, 2023, the content of which is incorporated by reference herein in its entirety.

### TECHNICAL FIELD

The invention generally relates to wireless communications, and, more particularly, to a data communications system for providing two-way transmission of digital data within the 12 GHz band.

### BACKGROUND

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems.

While 5G and even next-generation (post-5G) wireless networks promise increased speed, less latency, and more capacity than prior technologies, such network services can remain limited, both in terms of speed of transmission and overall transmission bandwidth, as a result of the specific spectrum bands currently used. In particular, operators typically use a combination of different spectrum bands to deliver 5G services, which plays a critical role in determining the speed and range of coverage. More specifically, the GSMA, a global trade organization that represents mobile operators, recommends that regulators and government agencies that control 5G spectrum allocation make 80-100 MHz of contiguous spectrum available per operator in prime 5G bands and about 1 GHz of spectrum per operator available in millimeter wave bands. Because spectrum is a scarce resource, wireless operators around the world generally use a mix of low-band, mid-band, and high-band spectrum to deliver the type of 5G experience that their customers demand. However, each spectrum has its advantages and disadvantages.

For example, low-band spectrum is any spectrum that is lower than 1 GHz on the spectrum chart, in which early wireless networks, often referred to as analog cellular, were deployed in low-band 800 MHz spectrum. For 5G communications, the low-band spectrum makes it possible for operators to provide a wide-swath of coverage, but the speed and latency of the 5G network is only incrementally better than what is delivered with 4G networks. As such, much of the 5G network's performance is dependent upon an end user's proximity to a cellular site. A mid-band spectrum is a spectrum in the 1 GHz-6 GHz range and is currently considered the most ideal for 5G because it can carry plenty of data while also traveling significant distances. A high-band spectrum is in the millimeter wave spectrum, which is in the 24 GHZ band and higher. Millimeter wave spectrum is limited because signals are unable to travel very far (i.e., in some cases the signal will travel less than a mile) and the signals are also susceptible to interference from objects (e.g., buildings, trees, etc.).

As such, spectrum plays a key role in the type of data communications service that operators will be able to provide to their customers. While a high-band spectrum may provide fast speeds and increased bandwidth, such transmission is highly dependent on the proximity of an end user relative to the cellular site. On the other hand, while a low-band spectrum may provide excellent overall blanket coverage, the network performance may only be a small improvement from prior cellular network technology standards (i.e., 4G and earlier).

### SUMMARY

The present invention is directed generally to a data communications system for providing two-way transmission of digital data within the 12 GHz band.

The 12 GHz band is recognized as offering high bandwidth with a relatively long wavelength compared to high-band options. For example, current high-band 5G deployments are designed to operate within the 24 GHz band (or higher), but are limited in coverage (e.g., coverage may be 1 mile or less). The 12 GHz band provides much greater coverage than what the 24 GHz band currently offers, thereby making it an attractive intermediary with sufficient speeds and adequate bandwidth to support low-latency 5G applications and further free up space within the 24 GHz band to support 5G's most demanding use cases, such as autonomous vehicles and the like. Furthermore, the 12 GHz band is extremely attractive to internet service providers (ISPs), in that a given ISP may have equipment broadcasting on a licensed pathway that gives them an exclusive frequency on which to build their network.

The system of the present invention provides a point-to-multipoint (P2MP, PTMP, or PMP) communication network including radios capable of transmitting inbound and outbound data over a default frequency range (i.e., typical frequency over which the given data is generally transmitted) as well as within 500 MHz of mid-band spectrum between 12.2-12.7 GHZ of the 12 GHz band.

For example, a given PTMP radio of the present invention generally comprises circuitry and logic allowing for the radio to communicate both on a first frequency band as well as the 500 MHz contiguous spectrum of the 12 GHz band. A given PTMP radio may generally include at least a first circuitry (i.e., a 5 GHz board) including a 5G chipset allowing for the radio to communicate using a 5G NR communications protocol and convey radio-frequency signals using component carriers in the Frequency Range 1 (FR1) frequency range and/or the Frequency Range 2 (FR2) frequency range of the 5G NR communications protocol. The radio further comprises at least a second circuitry (i.e., a 12 GHz board) allowing for the radio to transmit data over the 500 MHz contiguous spectrum of the 12 GHz band. The 5 GHz board and 12 GHZ boards are configured to cooperatively provide for upconverting of outbound signals for transmission over the 12 GHz band and downconverting of incoming signals transmitted over the 12 GHz band to a default transmission frequency via logic associated therewith.

The radio may further include wireless communication circuitry allowing for communication over the IEEE 802.11ax standard, such as the QUALCOMM 802.11ax solution, including Multi-User Multiple Input Multiple Output (MU-MIMO) technology, which allows the for increased network capacity (by a factor of 2× to 3× in typical cases), more traffic over the network (no time-sharing means less wait time), and increased spectral efficiency (multiplies total capacity to network by 2×-3×). The radio is further configured to be remotely controlled and configured on-the-fly, thereby allowing for software updates and the like and maintaining the radio to be current with any FCC-related rule changes and other market demands.

The system of the present invention includes at least a first radio that may be embodied as an access point (AP) for example. The AP radio may be embodied as a 90-degree Multi Point radio that can broadcast from a tower or rooftop to multiple buildings (e.g., 10, 20, 30, or more depending on type of service). The system may further include at least a second radio in the form of a customer-premises equipment (CPE) for communicating with the AP. The CPE may generally be installed at the subscriber's premises and connected with a carrier's communication circuit via the AP radio. For example, the CPE may generally include a dual use antenna at a 5G frequency range and 12 GHz frequency range, which can be mounted on a pole or the side of a building.

Accordingly, by providing two-way transmission of digital data within the 12 GHz band, the data communications system of the present invention provides network operators a cost effective and exclusive frequency to deploy PTMP wireless networks in a multitude of scenarios and environments, thereby taking advantage of the speed and propagation of 12 GHz, while using cutting edge 5G technologies.

### BRIEF DESCRIPTION OF THE DRAWINGS

FIG. 1 is a block diagram illustrating one embodiment of an exemplary data communications system for providing two-way transmission of digital data within the 12 GHz band consistent with the present disclosure.

FIGS. 2A and 2B are perspective views of an exemplary access point (AP) radio for use in the data communications system of the present disclosure.

FIGS. 3A and 3B are perspective views of an exemplary consumer-premises equipment (CPE) radio for use in the data communications system of the present disclosure.

FIG. 4 is a block diagram illustrating a communication network including radios capable of transmitting inbound and outbound digital data within 500 MHz of mid-band spectrum between 12.2-12.7 GHz of the 12 GHz band.

FIG. 5 is a circuit diagram representing one embodiment of a 12 GHz board consistent with the present disclosure.

### DETAILED DESCRIPTION

By way of overview, the present invention is directed to a data communications system for providing two-way transmission of data within the 12 GHz band.

Over the last few years, there has been increasing demand for the U.S. Federal Communications Commission (FCC) to update rules regarding use of the 12 GHz band for telecommunications. In the United States, the 12 GHz band is allocated on a primary basis for non-Federal use for Broadcasting Satellite Service (BSS) (referred to domestically in the band as Direct Broadcast Satellite (DBS)), Fixed Satellite Service (space-to-Earth) limited to non-geostationary orbit systems (NGSO FSS), and Fixed Service. Currently there are three services authorized and operating in the band: DBS providers operating under the primary BSS allocation; Multi-Channel Video and Data Distribution Service (MVDDS) licensees operating on a non-harmful interference basis to DBS under the co-primary Fixed Service allocation; and NGSO licensees operating on a non-harmful interference basis to DBS under the co-primary NGSO FSS allocation.

A coalition was formed (5G for 12 GHz Coalition), which includes MVDDS licensees Dish Network and RS Access. This coalition has been urging the FCC to change the rules for the 12 GHz band so it can be used for two-way 5G communications. The coalition claims that engineering studies have been performed and show that the band, specifically the 500 MHz of mid-band spectrum between 12.2-12.7 GHZ (of the 12 GHz band) could be safely used by both satellite and 5G service providers. The FCC, specifically its Office of Engineering and Technology (OET), has been evaluating the safety and feasibility of expanding use of the 12 GHz band for two-way terrestrial communications, with the goal of ensuring that spectrum is put to its highest and best use.

The 12 GHz band is recognized as offering high bandwidth with a relatively long wavelength compared to high-band options. For example, current high-band 5G deployments are designed to operate within the 24 GHz band (or higher), but are limited in coverage (e.g., coverage may be 1 mile or less). The 12 GHz band provides much greater coverage than what the 24 GHz band currently offers, thereby making it an attractive intermediary with sufficient speeds and adequate bandwidth to support low-latency 5G applications and further free up space within the 24 GHz band to support 5G's most demanding use cases, such as autonomous vehicles and the like. Furthermore, the 12 GHz band is extremely attractive to internet service providers (ISPs), in that a given ISP may have equipment broadcasting on a licensed pathway that gives them an exclusive frequency on which to build their network.

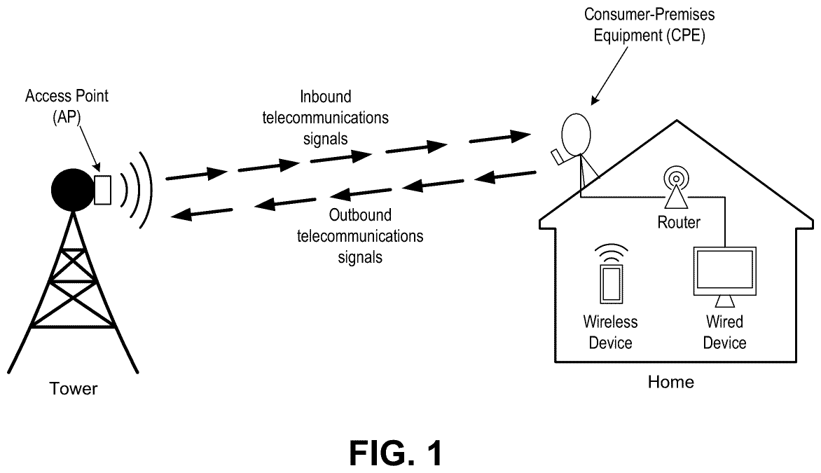

FIG. 1 is a block diagram illustrating one embodiment of an exemplary data communications system for providing two-way transmission of digital data within the 12 GHZ band consistent with the present disclosure. For example, as illustrated, the system provides a network, which generally includes radios in the form of an access point (AP) and consumer-premises equipment (CPE). The network may include, for example, a point-to-multipoint (P2MP, PTMP, or PMP) communication network. As will be described in greater detail herein, the radios are capable of transmitting inbound and outbound digital data over a default frequency range (i.e., typical frequency over which the given data is generally transmitted) and within a second frequency range (i.e., the 500 MHz of mid-band spectrum between 12.2-12.7 GHZ of the 12 GHz band).

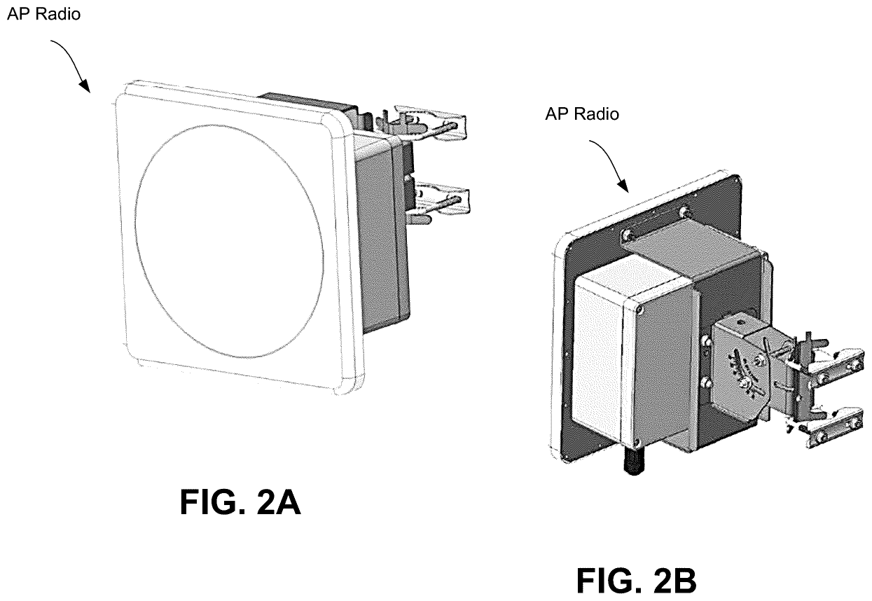

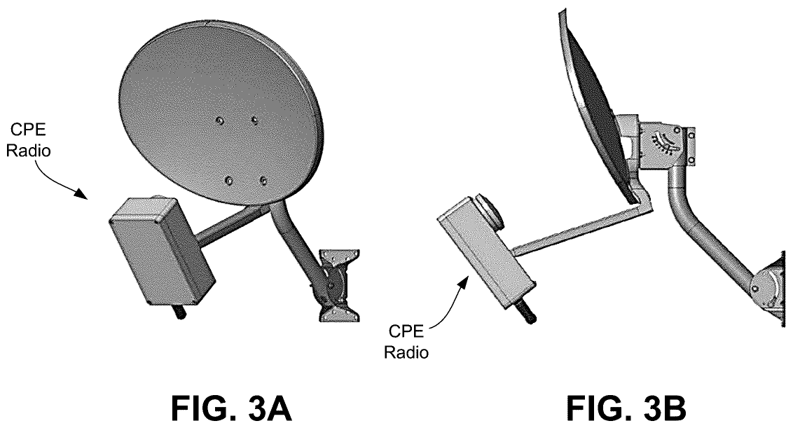

FIGS. 2A and 2B are perspective views of an exemplary access point (AP) radio for use in the data communications system of the present disclosure. FIGS. 3A and 3B are perspective views of an exemplary consumer-premises equipment (CPE) radio for use in the data communications system of the present disclosure. As shown, the AP radio may be embodied as a 90-degree Multi Point radio that can broadcast from a tower or rooftop to multiple buildings (e.g., 10, 20, 30, or more depending on type of service). The system further includes CPE for communicating with the AP. As shown, the CPE's antenna may include a satellite dish style design. However, it should be noted that the illustrated CPE of FIGS. 3A and 3B are merely for illustrative purposes and the CPE antenna may include other designs. The CPE radio may generally be installed at the subscriber's premises and connected with a carrier's communication circuit via the AP radio. For example, the CPE may generally include a dual use antenna, operable at a first frequency range (i.e., typical frequency over which the given data is generally transmitted, such as 5G frequency range or the like) and a 12 GHz frequency range, which can be mounted on a pole or the side of a building. As shown, communication between radios may include transmission of signals via a 5G NR communications protocol (i.e., FR1, FR2, etc.) and/or transmission of signals over a spectrum within the 12 GHz band.

A given PTMP radio of the present invention generally comprises circuitry and logic allowing for the radio to communicate both on the 5G common bands as well as the 500 MHZ contiguous spectrum of the 12 GHz band. More specifically, a PTMP radio comprises at least a first circuitry (i.e., a 5 GHz board) including a 5G chipset allowing for the radio to communicate using a 5G NR communications protocol and convey radio-frequency signals using component carriers in the Frequency Range 1 (FR1) frequency range and/or the Frequency Range 2 (FR2) frequency range of the 5G NR communications protocol, for example. The radio further comprises at least a second circuitry (i.e., a 12 GHz board) allowing for the radio to transmit 5G data over the 500 MHz contiguous spectrum of the 12 GHz band. The 5 GHz board and 12 GHZ board are configured to cooperatively provide for upconverting of outbound signals for transmission over the 12 GHz band and downconverting of incoming signals from the 12 GHZ band via logic associated therewith.

The radio may further comprise wireless communication circuitry allowing for communication over the IEEE 802.11ax standard, such as the QUALCOMM 802.11ax solution, including Multi-User Multiple Input Multiple Output (MU-MIMO) technology, which allows the for increased network capacity (by a factor of 2× to 3× in typical cases), more traffic over the network (no time-sharing means less wait time), and increased spectral efficiency (multiplies total capacity to network by 2-3×). The radio is further configured to be remotely controlled and configured on-the-fly, thereby allowing for software updates and the like and maintaining the radio to be current with any FCC-related rule changes and other market demands.

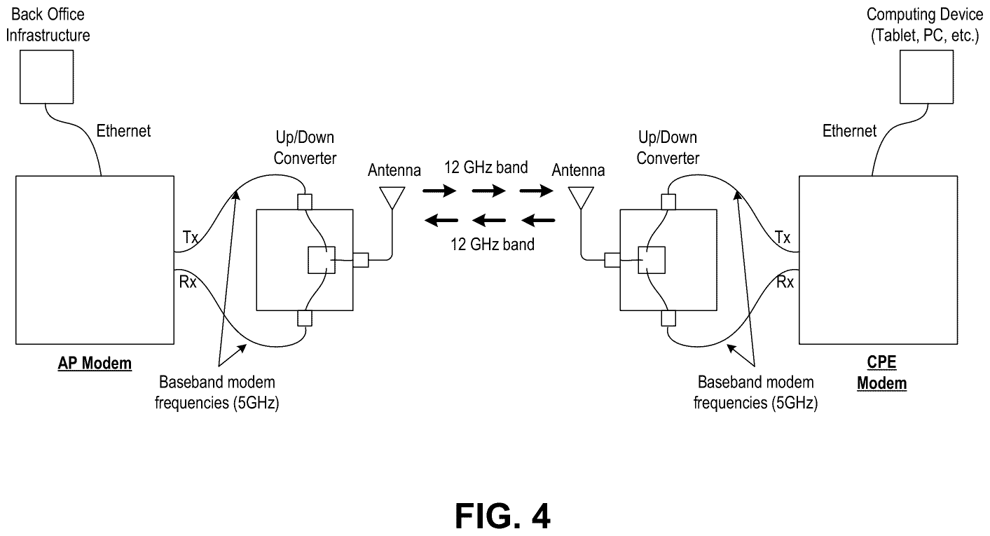

FIG. 4 is a block diagram illustrating a communication network including radios capable of transmitting inbound and outbound 5G data within 500 MHz of mid-band spectrum between 12.2-12.7 GHz of the 12 GHz band.

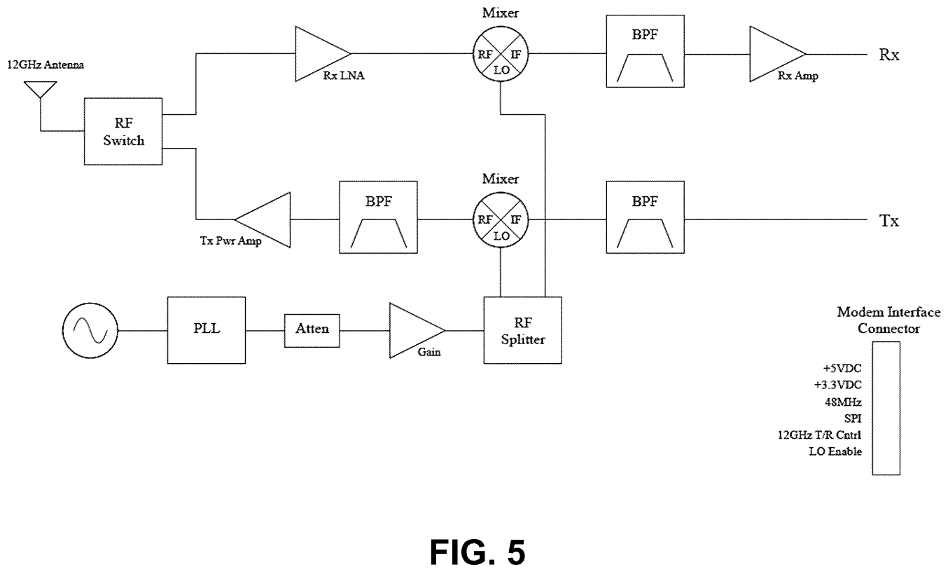

FIG. 5 is a circuit diagram representing one embodiment of a 12 GHz board consistent with the present disclosure.

Accordingly, by providing two-way transmission of digital data within the 12 GHz band, the data communications system of the present invention provides network operators a cost effective and exclusive frequency to deploy PTMP wireless networks in a multitude of scenarios and environments, thereby taking advantage of the speed and propagation of 12 GHz, while using cutting edge 5G technologies.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A data communications system for providing two-way transmission of digital data within the 12 GHz band, the system comprising one or more radios, each radio being capable of transmitting inbound and outbound digital data over a first frequency range associated with a default frequency over which the digital data is typically transmitted and over a second frequency range within 500 MHz of mid-band spectrum between 12.2-12.7 GHZ of the 12 GHz band.

2. The data communications system of claim 1, wherein the first frequency range is within a 5G frequency range.

3. The data communications system of claim 2, wherein the first frequency range is associated with a 5G NR communications protocol.

4. The data communications system of claim 1, wherein the one or more radios are configured to communicate and transmit data over a network.

5. The data communications system of claim 4, wherein the network comprises a point-to-multipoint communication (PTMP) network.

6. The data communications system of claim 5, wherein each of the one or more radios comprises a PTMP-enabled radio.

7. The data communications system of claim 5, wherein the one or more radios comprises at least a first radio in the form of an access point (AP) radio and a second radio in the form of a consumer-premises equipment (CPE) radio configured to communicate with the AP radio.

8. The data communications system of claim 7, wherein the AP radio and CPE radio are configured to communicate with one another via at least one of a 5G NR communications protocol and over a spectrum within the 12 GHz band.

9. The data communications system of claim 1, wherein each of the one or more radios comprises circuitry and logic allowing for each of the one or more radios to communicate both on the 5G common bands as well as the 500 MHz contiguous spectrum of the 12 GHz band.

10. The data communications system of claim 9, wherein each of the one or more radios comprises:
at least a first circuitry configured allow for communication, including transmission of data, using a 5G NR communications protocol and convey radio-frequency signals using component carriers in the Frequency Range 1 (FR1) frequency range and/or the Frequency Range 2 (FR2) frequency range of the 5G NR communications protocol; and
at least a second circuitry configured to allow transmission of 5G data over the 500 MHz contiguous spectrum of the 12 GHz band.

11. The data communications system of claim 10, wherein the first circuitry and second circuitry are configured to cooperatively provide for upconverting of outbound signals for transmission over the 12 GHz band and downconverting of incoming signals from the 12 GHz band via logic associated therewith.

12. The data communications system of claim 10, wherein each of the one or more radios comprises wireless communication circuitry allowing for communication over a IEEE 802.11ax standard.

13. The data communications system of claim 9, wherein each of the one or more radios is further configured to be remotely controlled and configured on-the-fly.

14. A method for providing two-way transmission of digital data within the 12 GHz band, the method comprising:
receiving a signal associated with digital data over a first frequency range associated with a 5G NR communications protocol; and
upconverting the signal to be subsequently transmitted over a second frequency range within a spectrum of the 12 GHz band.

15. A method for providing two-way transmission of digital data within the 12 GHz band, the method comprising:
receiving a signal associated with digital data over a first frequency range within a spectrum of the 12 GHz band; and
downconverting the signal to be subsequently transmitted over a second frequency range associated with a 5G NR communications protocol.
